(19) United States
(12) Patent Application Publication
(10) Pub. No.: US 2011/0221744 A1
(43) Pub. Date: Sep. 15, 2011

(54) STEREOSCOPIC IMAGE DISPLAY DEVICE

(75) Inventors: Jae-Sung BAE, Suwon-si (KR); Bong-Hyun YOU, Yongin-si (KR); Jai-Hyun KOH, Anyang-si (KR)

(73) Assignee: SAMSUNG ELECTRONICS CO., LTD., Suwon-si (KR)

(21) Appl. No.: 12/964,160

(22) Filed: Dec. 9, 2010

(30) Foreign Application Priority Data
Mar. 12, 2010 (KR) 10-2010-0022385

(51) Int. Cl. G06T 15/00

(52) U.S. Cl. 345/419

(57) ABSTRACT

A stereoscopic image display device for realizing a three-dimensional image includes; an image display device including an image display area having a plurality of pixels, each pixel of the plurality of pixels being composed of two sub-pixels selected from a group of a first sub-pixel, a second sub-pixel, a third sub-pixel and a fourth sub-pixel, and a retarder disposed on the image display device and configured to convert a linearly polarized image from the image display device into left-handed circularly polarized light and right-handed circularly polarized light.

This application claims priority to Korean Patent Application No. 10-2010-0022385, filed on Mar. 12, 2010, and all the benefits accruing therefrom under 35 U.S.C. §119, the content of which in its entirety is herein incorporated by reference.

### BACKGROUND OF THE INVENTION

(a) Field of the Invention

The present invention relates to a stereoscopic image display device.

(b) Description of the Related Art

In the field of three-dimensional (“3D”) image display technologies, in general, a 3D appearance of an object is represented via binocular parallax, which is one of the primary causes of 3D appearance perception at close range. That is, different images are seen by the left eye and the right eye. Hereinafter, an image seen by the left eye is referred to as a left eye image and an image seen by the right eye is referred to as a right eye image. A left eye image and a right eye image are transmitted to the brain, which combines the left eye image and the right eye image to perceive them as a 3D image having depth information.

A stereoscopic image display device utilizes the above-described binocular disparity and may generally be categorized into different types of display device, such as a stereoscopic type display using glasses such as shutter glasses and/or polarized glasses and an autostereoscopic type display in which glasses are not used and a lenticular lens, a parallax barrier, and/or other types of devices are disposed on a display.

The stereoscopic type display which uses polarized glasses is a 3D image display in which a patterned retarder attached to a front face of a stereoscopic image display device polarizes a left eye image and a right eye image in different polarization directions and the left lens of the polarized glasses passes only the left eye image therethrough and the right lens of the polarized passes only the right eye image therethrough. The stereoscopic type display using polarized glasses is easy to be technically realized and can make visible 3D images with only lightweight polarized glasses and a patterned retarder.

However, in the case of a stereoscopic image display device using polarized glasses, an observer can see the even rows of the stereoscopic image display device through only the left eye and the odd rows of the stereoscopic image display device through only the right eye, which decreases resolution in a column direction. Moreover, since a patterned retarder is attached to the front face of the stereoscopic image display device, luminance may accordingly decrease.

### BRIEF SUMMARY OF THE INVENTION

The present invention provides a stereoscopic image display device having advantages of preventing a decrease in resolution in a column direction when used with a patterned retarder.

An exemplary embodiment of a stereoscopic image display device for realizing a 3D image may include; an image display device including an image display area having a plurality of pixels, each pixel of the plurality of pixels being composed of two sub-pixels selected from a group of a first to fourth sub-pixel, and a retarder disposed on the image display device and configured to convert a linearly polarized image from the image display device into only left-handed circularly polarized light and right-handed circularly polarized light.

In one exemplary embodiment, a parallax image which is obtained by combining a left eye image and a right eye image may be displayed on the first to the fourth sub-pixels.

In one exemplary embodiment, the two sub-pixels constituting each pixel may be either a red sub-pixel and a green sub-pixel or a blue sub-pixel and a white sub-pixel.

In one exemplary embodiment, the first to fourth sub-pixels of the image display area may correspond to a red sub-pixel, a green sub-pixel, a blue sub-pixel, and a white sub-pixel, respectively, and the image display area may include odd-numbered rows in which the red sub-pixel, the green sub-pixel, the blue sub-pixel, and the white sub-pixel are alternatingly and sequentially disposed in a row direction, and even-numbered rows in which the blue sub-pixel, the white sub-pixel, the red sub-pixel, and the green sub-pixel are alternatingly and sequentially disposed in a row direction.

In one exemplary embodiment, each odd-numbered row of the image display area may be paired with an even-numbered row adjacent to the corresponding odd-numbered row to form a plurality of row pairs, odd-numbered row pairs of the row pairs may constitute right eye image regions, and even-numbered row pairs of the row pairs may constitute left eye image regions.

In one exemplary embodiment, right-handed circularly polarizing parts of the retarder may be disposed corresponding to the right eye image regions, and left-handed circularly polarizing parts of the retarder may be disposed corresponding to the left eye image regions.

In one exemplary embodiment, an image corresponding to each pixel may be realized by a sub-pixel rendering method.

In one exemplary embodiment, the first to fourth sub-pixels of the image display area may correspond to a red sub-pixel, a green sub-pixel, a blue sub-pixel, and a white sub-pixel, respectively, and the image display area may include a first odd-numbered row in which the red sub-pixel, the green sub-pixel, the blue sub-pixel, and the white sub-pixel are alternatingly and sequentially disposed in a row direction, a first even-numbered row in which the blue sub-pixel, the white sub-pixel, the red sub-pixel, and the green sub-pixel are alternatingly and sequentially disposed in the row direction, a second odd-numbered row in which the blue sub-pixel, the white sub-pixel, the red sub-pixel, and the green sub-pixel are alternatingly and sequentially disposed in the row direction, and a second even-numbered row in which the red sub-pixel, the green sub-pixel, the blue sub-pixel, and the white sub-pixel are alternatingly and sequentially disposed in the row direction.

In one exemplary embodiment, each odd-numbered row of the image display area may constitute a right eye image region and each even-numbered row of the image display area may constitute a left eye image region.

In one exemplary embodiment, right-handed circularly polarizing parts of the retarder may be disposed corresponding to the right eye image regions, and left-handed circularly polarizing parts of the retarder may be disposed corresponding to the left eye image regions.

In one exemplary embodiment, an image corresponding to each pixel may be realized by a sub-pixels rendering method.

In one exemplary embodiment, the first to the fourth sub-pixels may operate as one pixel to realize a 2D image.

According to an exemplary embodiment of the present invention, since a Pentile RGBW Matrix scheme is applied to a stereoscopic image display device, it is possible to prevent resolution in a column direction from decreasing when a 3-D image is displayed as compared to the display of a 2-D image.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is an exploded perspective view illustrating an exemplary embodiment of a stereoscopic image display device according to the present invention;

FIG. 2 is a drawing illustrating an exemplary embodiment of an arrangement of pixels in an image display area of the exemplary embodiment of a stereoscopic image display device of FIG. 1;

FIG. 3 is a drawing illustrating an exemplary embodiment of a driving method when each pixel of the pixel arrangement of FIG. 2 is composed of one red sub-pixel and one green sub-pixel;

FIG. 4 is a drawing illustrating another exemplary embodiment of a driving method when each pixel of the pixel arrangement of FIG. 2 is composed of one red sub-pixel and one green sub-pixel;

FIG. 5 is a schematic diagram illustrating an exemplary embodiment of a method of realizing a 3D image in the exemplary embodiment of a pixel arrangement of FIG. 2;

FIG. 6 is an exploded perspective view illustrating another exemplary embodiment of a stereoscopic image display device according to the present invention;

FIG. 7 is a drawing illustrating an exemplary embodiment of an arrangement of an image display area of the exemplary embodiment of a stereoscopic image display device of FIG. 6; and

FIG. 8 is a schematic diagram illustrating an exemplary embodiment of a method of realizing a 3D image in the exemplary embodiment of a pixel arrangement of FIG. 6.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

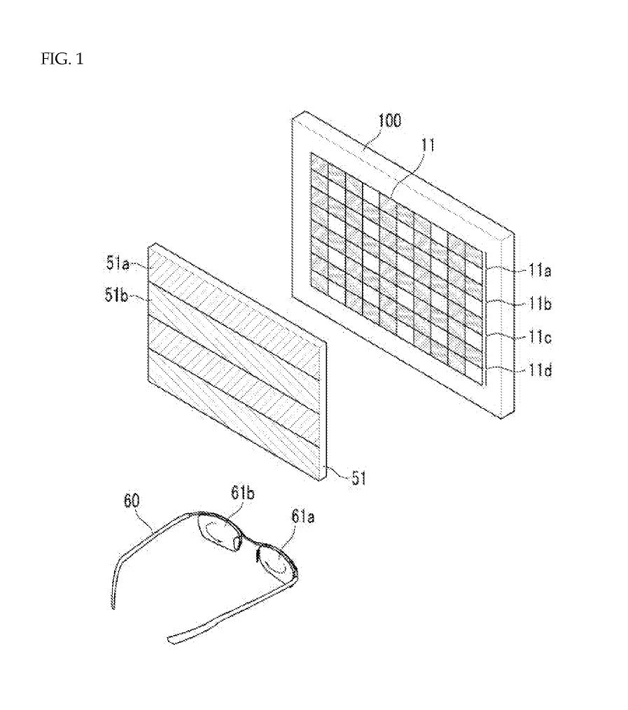

An exemplary embodiment of a stereoscopic image display device according to the present invention will now be described with reference to FIGS. 1 to 5.

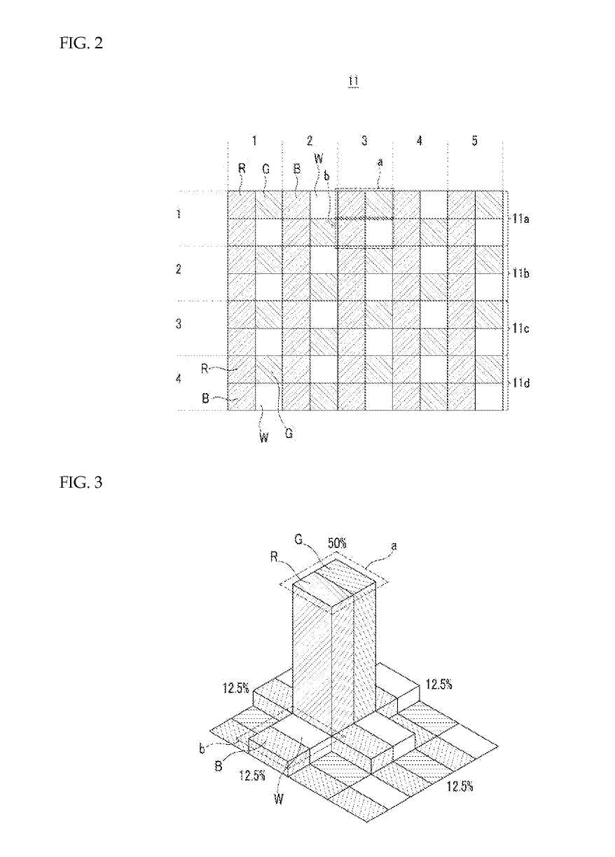

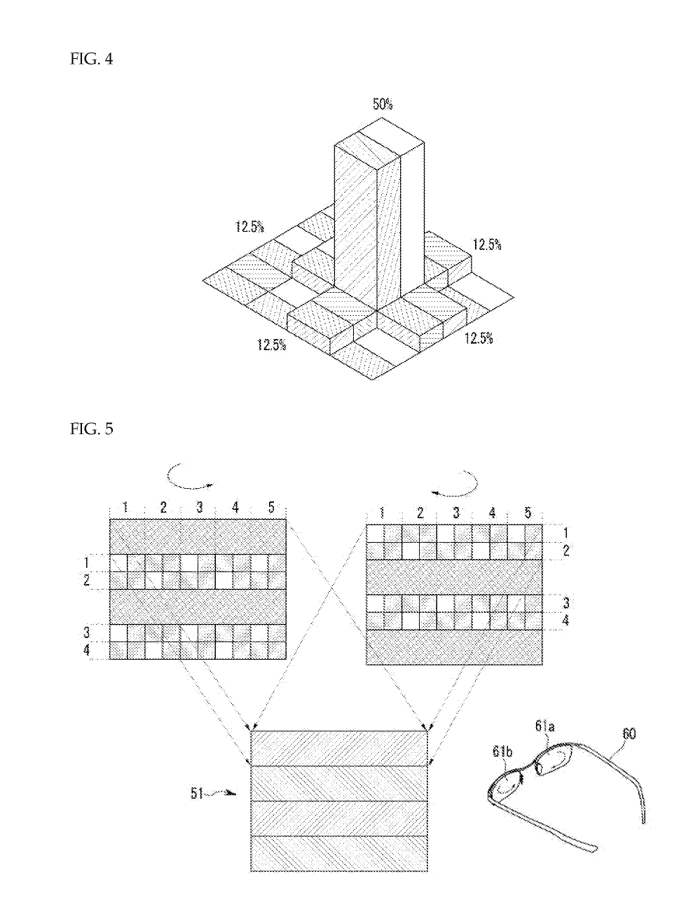

FIG. 1 is an exploded perspective view illustrating an exemplary embodiment of a stereoscopic image display device according to the present invention. FIG. 2 is a drawing illustrating an exemplary embodiment of an arrangement of pixels in an image display area of the exemplary embodiment of a stereoscopic image display device of FIG. 1. FIG. 3 is a drawing illustrating an exemplary embodiment of a driving method when each pixel of the exemplary embodiment of a pixel arrangement of FIG. 2 is composed of one red sub-pixel and one green sub-pixel. FIG. 4 is a drawing illustrating another exemplary embodiment of a driving method when each pixel of the exemplary embodiment of a pixel arrangement of FIG. 2 is composed of one red sub-pixel and one green sub-pixel. FIG. 5 is a schematic diagram illustrating an exemplary embodiment of a method of realizing a three-dimensional (“3D”) image in the pixel arrangement of FIG. 2.

As shown in FIG. 1, an exemplary embodiment of a stereoscopic image display device according to the present invention includes an image display device 100 and a retarder 51. The image display device 100 has an image display area 11 for displaying a parallax image which is obtained by combining a left eye image and a right eye image. The retarder 51 transforms a linearly polarized image displayed by the image display device 100 into left-handed circularly polarized light and right-handed circularly polarized light. The stereoscopic image display device may further include polarized glasses 60 for passing left-handed circularly polarized light and right-handed circularly polarized light from the retarder 51 through a left-handed circularly polarized filter 61b and a right-handed circularly polarized filter 61a, respectively, to allow an observer to see the left eye image using the left eye of the observer and the right eye image using the right eye of the observer. Thus, because each eye of the observer observes a different image, the observer may interpret the different images as a 3D image.

The image display device 100 may include a liquid crystal display (“LCD”), an organic light emitting device (“OLED”), or various other types of display devices. An exemplary embodiment wherein the image display device 100 is an LCD will be described below with reference to FIG. 1.

The image display device 100 may include an upper substrate (not shown), a lower substrate (not shown) and a liquid crystal layer (not shown) injected between the upper substrate and the lower substrate. The image display device 100 changes the alignment direction of liquid crystal molecules by controlling an electric field generated between two electrodes to adjust an amount of light transmitted through the display device 100, thereby displaying images with varying grayscale.

Gate lines (not shown), data lines (not shown), pixel electrodes (not shown) and thin film transistors (not shown) connected thereto are disposed on the lower substrate. The thin film transistors control voltages applied to the pixel electrodes on the basis of signals applied to the gate lines and the data lines. In one exemplary embodiment, the pixel electrodes may be transflective pixel electrodes each of which has a transmissive region and a reflective region. In addition, exemplary embodiments include configurations wherein storage capacitance capacitors (not shown) may be formed to maintain voltage applied to the pixel electrodes during a predetermined time period.

A black matrix, red, green and blue and white color filters, and a common electrode may be disposed on the upper substrate. Alternative exemplary embodiments include configurations wherein at least one of the color filters, the black matrix, and the common electrode may be formed on the lower substrate. In an exemplary embodiment wherein the common electrode and the pixel electrodes are all formed at the lower substrate, the common electrode and/or the pixel electrodes may be formed in a linear electrode form.

The liquid crystal layer may include a twisted nematic (“TN”) type of liquid crystal, a vertically aligned (“VA”) type of liquid crystal, an electrically controlled birefringence (“ECB”) type of liquid crystal, an in plane switching (“IPS”) mode liquid crystal, and various other types of liquid crystal.

A polarizer is attached to an external face of the upper substrate and an external face of the lower substrate. Also, exemplary embodiments include configurations wherein a compensation film may be added between each substrate and a corresponding polarizer.

A backlight unit includes a light source, and examples of the light source include a fluorescent lamp such as cold cathode fluorescent lamp (“CCFL”), light emitting diode (“LED”), and various other types of light sources. The backlight unit may further include a reflector, a light guide plate, a luminance improvement film, and various other components as would be known to one of ordinary skill in the art.

As shown in FIG. 2, in each odd-numbered row of the image display area 11, red sub-pixel R, green sub-pixel G, blue sub-pixel B, and white sub-pixel W are alternatingly and sequentially disposed in a row direction. In each even-numbered row of the image display area 11, blue sub-pixels B, white sub-pixels W, red sub-pixels R, and green sub-pixels G are alternatingly and sequentially disposed in the row direction. In each odd-numbered column of the image display area 11, red sub-pixels R and blue sub-pixels B are alternatingly disposed in a column direction. In each even-numbered column of the image display area 11, green sub-pixels G and white sub-pixels W are alternatingly disposed in the column direction.

In order to realize a two-dimensional (“2D”) image, four sub-pixels, which includes a red sub-pixel R and a green sub-pixel G located in an odd-numbered row and a blue sub-pixel B and a white sub-pixel W located in an even-numbered row neighboring the odd-numbered row, function as one pixel, i.e., a unit-pixel, as shown in FIG. 2. An image display area shown in FIG. 2 has a resolution of 5×4 dpi.

Meanwhile, in order to realize a 3D image, in the image display area 11, one odd-numbered row and the adjacent even-numbered row constitute a right eye image region 11a together, and an odd-numbered row below the right eye image region 11a and the next even-numbered row constitute a left eye image region 11b together. As described above, each odd-numbered row of the image display area 11 is paired with an even-numbered row adjacent to the corresponding odd-numbered row to form a plurality of row pairs. In the present exemplary embodiment, odd-numbered row pairs of the plurality of row pairs are referred to as right eye image regions, and even-numbered row pairs of the row pairs are referred to as left eye image regions. A right eye image is displayed on the right eye image regions and a left eye image is displayed on the left eye image regions. In FIGS. 1 and 2, reference numerals 11a and 11c represent right eye image regions and reference numerals 11b and 11d represent left eye image regions. Alternative exemplary embodiments include configurations wherein the odd-numbered row pairs display the left eye image and the even numbered row pairs display the right eye image, opposite to that described above.

The retarder 51 is provided on the image display area 11. In the retarder 51, right-handed circularly polarizing parts 51a and left-handed circularly polarizing parts 51b are alternatingly disposed. The right-handed circularly polarizing parts 51a delay the phase of linearly polarized light having passed through the image display area 11 to convert it into right-handed circularly polarized light, and the left-handed circularly polarizing parts 51b delay the phase of the linearly polarized light having passed through the image display area 11 to convert it into left-handed circularly polarized light whose phase is substantially perpendicular to that of the right-handed circularly polarized light.

The right-handed circularly polarizing parts 51a are disposed corresponding to the right eye image regions 11a and 11c, and the left-handed circularly polarizing parts 51b are disposed corresponding to the left eye image regions 11b and 11d. Therefore, the right-handed circularly polarizing parts 51a of the retarder 51 polarize the right eye image to have a right-handed circular polarization and the left-handed circularly polarizing parts 51b polarize the left eye image to have a left-handed circular polarization.

The polarized glasses 60 includes a right-handed circularly polarizing filter 61a disposed in a right lens and a left-handed circularly polarizing filter 61b disposed in a left lens. The right-handed circularly polarizing filter 61a passes only the right-handed circularly polarized light, and the left-handed circularly polarizing filter 61b passes only the left-handed circularly polarized light.

Therefore, the right eye image having right-handed circularly polarized light received through the right-handed circularly polarizing filter 61a falls on only the right eye of the observer and the left eye image having left-handed circularly polarized light received through the left-handed circularly polarizing filter 61b falls on only the left eye of the observer, which makes the observer receive two separate images, one for each eye, and is thus capable of perceiving a 3D image corresponding to the right eye image and the left eye image.

Since the right eye of the observer can see only the right eye image and the left eye of the observer can see only the left eye image, resolution in the column direction decreases, e.g., only half of the column from a top of the image display area to a bottom of the image display area is observed by each eye.

For this reason, in the exemplary embodiment of the present invention, in order to realize a 3D image, an image is displayed in a Pentile RGBW Matrix scheme in which there are pixels ‘a’ each of which is composed of one red sub-pixel R and one green sub-pixel G and pixels ‘b’ each of which is composed of one blue sub-pixel B and one white sub-pixel W as shown in FIG. 2, and which operate by a sub-pixel rendering method using sub-pixels adjacent to each other in the row direction or the column direction.

In the Pentile RGBW Matrix scheme, the sub-pixels rendering method is a driving method which distributes red, green, and blue image data to one pixel composed of two sub-pixels and pixels vertically and horizontally neighboring the corresponding pixel in a predetermined ratio such that the pixels display an image as one pixel composed of two sub-pixels does.

In general, pixel ‘a’ is composed of a red sub-pixel R, a green sub-pixel G, blue sub-pixel B, and a white sub-pixel W. When pixel ‘a’ is perceived as white color, 25% of an image data displaying white color is a red image data, 25% of an image data displaying white color is a green image data, 25% of an image data displaying white color is a blue image data and 25% of an image data displaying of white color is a white image data.

However, in the exemplary embodiment of a stereoscopic image display device according to the present invention, as shown in FIG. 3, the pixels ‘a’ is composed of the red sub-pixel R and the green sub-pixel G, each of four pixels ‘b’ which are vertically and horizontally neighboring the pixel ‘a’ is composed of the blue sub-pixel B and the white sub-pixel W.

When pixel ‘a’ and pixel ‘b’ are perceived as white color, 50% of an image data displaying white color are a sum of the red image data and the green image data input to the pixel ‘a’ and another 50% of an image data displaying white color are a sum of the white image data and the blue image data input to the four pixels ‘b’.

In other words, 12.5% of an image data displaying white color is a sum of the white image data and the blue image data input to the pixel ‘b’.

Also, as shown in FIG. 4, the case of a pixel ‘b’ composed of a blue sub-pixel B and a white sub-pixel W is substantially similar to the case of a pixel ‘a’ composed of a red sub-pixels R and a green sub-pixels G.

Therefore, a 3D image is displayed using the Pentile RGBW Matrix scheme as shown in FIG. 5 such that the image display area 11 has the resolution of 5×4 dpi, the same as if the display were displaying a 2-D image, thereby preventing the resolution from decreasing.

At this time, since both of the left eye image and the right eye image are displayed on every other image display region, that is, every other row pair, the 3D image actually seen by the eyes may look rough due to the pairing of blank and/or image displaying rows. Therefore, another exemplary embodiment of the present invention to supplement this will be described below.

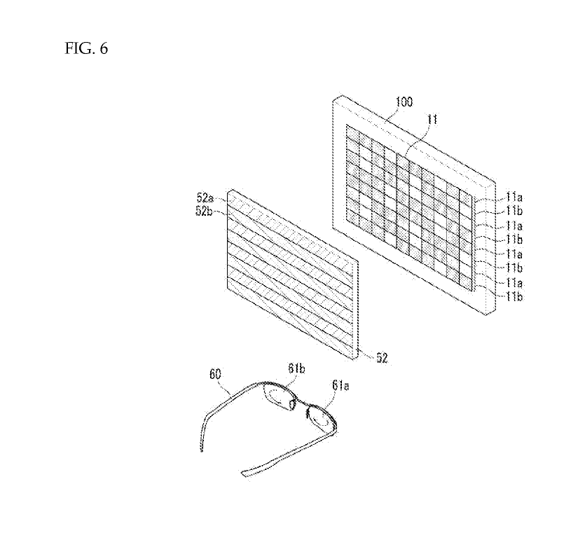

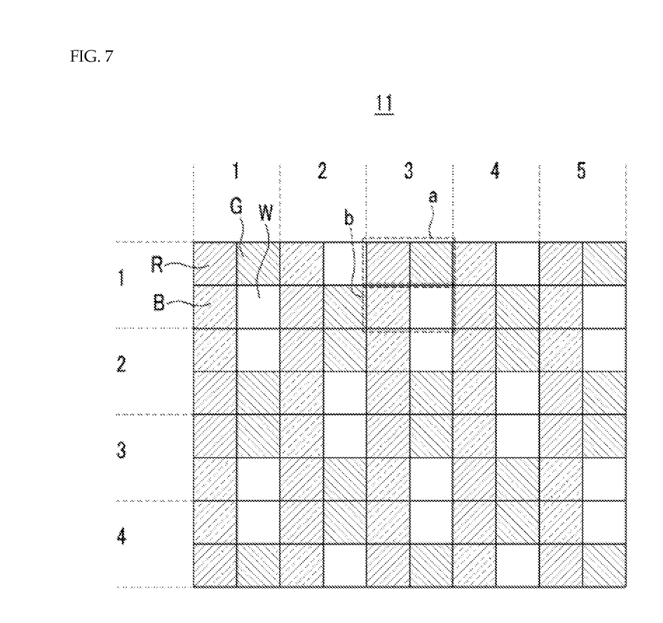

Another exemplary embodiment of a stereoscopic image display device according to another exemplary embodiment of the present invention will be described with reference to FIGS. 6 to 8.

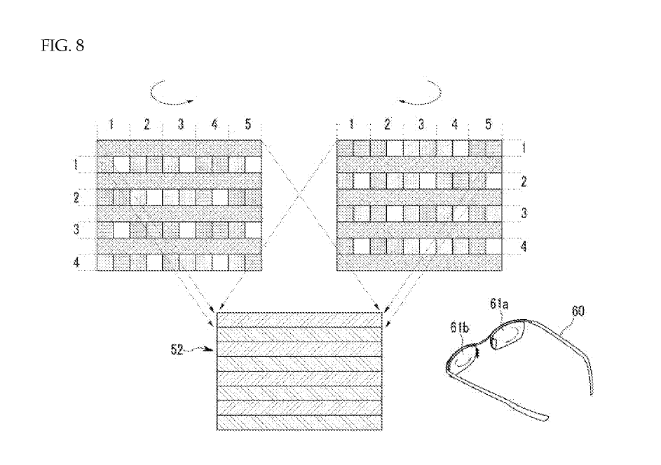

FIG. 6 is an exploded perspective view illustrating another exemplary embodiment of a stereoscopic image display device according to the present invention. FIG. 7 is a drawing illustrating an exemplary embodiment of a pixel arrangement of an image display area of the exemplary embodiment of a stereoscopic image display device of FIG. 6. FIG. 8 is a schematic diagram illustrating a method of realizing a 3D image in the exemplary embodiment of a pixel arrangement of FIG. 6.

As shown in FIG. 6, another exemplary embodiment of a stereoscopic image display device according to the present invention includes an image display device 100 and a retarder 52. The image display device 100 has an image display area 11 for displaying a parallax image which is obtained by combining a left eye image and a right eye image. The retarder 51 transforms a linearly polarized image having passed through the image display device 100 into left-handed circularly polarized light and right-handed circularly polarized light. The stereoscopic image display device may further include polarized glasses 60 for passing left-handed circularly polarized light and right-handed circularly polarized light from the retarder 52 through a left-handed circularly polarized filter 61b and a right-handed circularly polarized filter 61a, respectively, of the glasses 60 to allow an observer to see a 3D image.

As shown in FIG. 7, in the first odd-numbered row of the image display area 11, red sub-pixels R, green sub-pixels G, blue sub-pixels B, and white sub-pixels W are alternatingly and sequentially disposed in a row direction. In the first even-numbered row of the image display area 11, blue sub-pixels B, white sub-pixels W, red sub-pixels R, and green sub-pixels G are alternatingly and sequentially disposed in the row direction. In the second odd-numbered row of the image display area 11, blue sub-pixels B, white sub-pixels W, red sub-pixels R, and green sub-pixels G are alternatingly and sequentially disposed in the row direction. In the second even-numbered row of the image display area 11, red sub-pixels R, green sub-pixels G, blue sub-pixels B, and white sub-pixels W are alternatingly and sequentially disposed in the row direction.

In the first odd-numbered column of the image display area 11, red sub-pixels R, blue sub-pixels B, blue sub-pixels B, and red sub-pixels R are alternatingly disposed in a column direction. In the first even-numbered column of the image display area 11, green sub-pixels G, white sub-pixels W, white sub-pixels W, and green sub-pixels G are alternatingly disposed in the column direction. In the second odd-numbered column of the image display area 11, blue sub-pixels B, red sub-pixels R, red sub-pixels R, and blue sub-pixels B are alternatingly disposed in the column direction. In the second even-numbered column of the image display area 11, white sub-pixels W, green sub-pixels G, green sub-pixels G, and white sub-pixels W are alternatingly disposed in the column direction.

In order to realize a 2D image, four sub-pixels, which includes a red sub-pixel R and a green sub-pixel G located in an odd-numbered row and a blue sub-pixel B and a white sub-pixel W located in an even-numbered row adjacent to the odd-numbered row, functions as one pixel as shown in FIG. 2, i.e., a unit pixel. An image display area shown in FIG. 2 and FIG. 7 has a resolution of 5×4 dpi.

Meanwhile, in order to realize a 3D image, in the image display area 11, odd-numbered rows constitute right eye image regions 11a, and odd-numbered rows constitute left eye image regions 11b. As described above, the right eye image regions 11a and the left eye image regions 11b are alternatingly disposed in the column direction. A right eye image is displayed on the right eye image regions 11a and a left eye image is displayed on the left eye image regions 11b.

The retarder 52 is provided on the image display area 11. In the retarder 52, right-handed circularly polarizing parts 52a and left-handed circularly polarizing parts 52b are alternatingly disposed. The right-handed circularly polarizing parts 52a delay the phase of linearly polarized light having passed through the image display area 11 to convert it into right-handed circularly polarized light, and the left-handed circularly polarizing parts 52b delay the phase of the linearly polarized light having passed through the image display area 11 to convert it into left-handed circularly polarized light whose phase is substantially perpendicular to that of the right-handed circularly polarized light.

The right-handed circularly polarizing parts 52a are disposed corresponding to the right eye image regions 11a and 11c, and the left-handed circularly polarizing parts 52b are disposed corresponding to the left eye image regions 11b and 11d. Therefore, the right-handed circularly polarizing parts 52a of the retarder 52 polarize the right eye image to have a right-handed circular polarization and the left-handed circularly polarizing parts 52b polarize the left eye image to have a left-handed circular polarization.

The polarized glasses 60 includes a right-handed circularly polarizing filter 61a disposed in a right lens and a left-handed circularly polarizing filter 61b disposed in a left lens. The right-handed circularly polarizing filter 61a passes only the right-handed circularly polarized light, and the left-handed circularly polarizing filter 61b passes only the left-handed circularly polarized light.

Therefore, the right eye image having right-handed circularly polarized due to the right-handed circularly polarizing filter 61a falls on only the right eye of the observer and the left eye image having left-handed circularly polarized due to the left-handed circularly polarizing filter 61b falls on only left eye of the observer, which makes the observer capable of perceiving a 3D image by perceiving the right eye image and the left eye image in different eyes of the observer.

Since the right eye of the observer can see only the right eye image and the left eye of the observer can see only the left eye image, resolution in the column direction decreases.

For this reason, in the exemplary embodiment of the present invention, in order to realize a 3D image, an image is displayed in a Pentile RGBW Matrix scheme in which there are pixels ‘a’ each of which is composed of one red sub-pixel R and one green sub-pixel G and pixels ‘b’ each of which is composed of one blue sub-pixel B and one white sub-pixel W as shown in FIG. 7, and which operates by a sub-pixel rendering method using sub-pixels adjacent to each other in the row direction or the column direction.

Therefore, a 3D image is displayed using the Pentile RGBW Matrix scheme as shown in FIG. 8 such that the image display area 11 has the resolution of 5×4 dpi, thereby preventing the resolution from decreasing.

At this time, since both of the left eye image and the right eye image are displayed in every other row, the 3D image actually seen by the eyes may look smoother as compared to the exemplary embodiment of the present invention shown in FIGS. 1 to 5 wherein row pairs are displayed in each of the left eye image and the right eye image.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stereoscopic image display device for realizing a three-dimensional image, the stereoscopic image display device comprising:
an image display device including an image display area having a plurality of pixels, each pixel of the plurality of pixels being composed of two sub-pixels selected from a group of a first sub-pixel, a second sub-pixel, a third sub-pixel and a fourth sub-pixel; and
a retarder disposed on the image display device and configured to convert a linearly polarized image from the image display device into only left-handed circularly polarized light and right-handed circularly polarized light.

2. The apparatus of claim 1, wherein a parallax image which is obtained by combining a left eye image and a right eye image is displayed on the first sub-pixel, the second sub-pixel, the third sub-pixel and the fourth sub-pixel.

3. The apparatus of claim 2, wherein the two sub-pixels constituting each pixel of the plurality of pixels are either a red sub-pixel and a green sub-pixel or a blue sub-pixel and a white sub-pixel.

4. The apparatus of claim 3, wherein the first sub-pixel, the second sub-pixel, the third sub-pixel and fourth sub-pixel of the image display area correspond to a red sub-pixel, a green sub-pixel, a blue sub-pixel, and a white sub-pixel, respectively, and
the image display area comprises:
odd-numbered rows in which the red sub-pixel, the green sub-pixel, the blue sub-pixel, and the white sub-pixel are alternatingly and sequentially disposed in a row direction, and
even-numbered rows in which the blue sub-pixel, the white sub-pixel, the red sub-pixel, and the green sub-pixel are alternatingly and sequentially disposed in a row direction.

5. The apparatus of claim 4, wherein each odd-numbered row of the image display area is paired with an even-numbered row adjacent to the corresponding odd-numbered row to form a plurality of row pairs, odd-numbered row pairs of the plurality of row pairs constitute right eye image regions, and even-numbered row pairs of the plurality of row pairs constitute left eye image regions.

6. The apparatus of claim 5, wherein right-handed circularly polarizing parts of the retarder are disposed corresponding to the right eye image regions, and left-handed circularly polarizing parts of the retarder are disposed corresponding to the left eye image regions.

7. The apparatus of claim 6, wherein an image corresponding to each pixel is displayed using a sub-pixel rendering method.

8. The apparatus of claim 3, wherein the first sub-pixel, the second sub-pixel, the third sub-pixel and fourth sub-pixel of the image display area correspond to a red sub-pixel, a green sub-pixel, a blue sub-pixel, and a white sub-pixel, respectively, and
the image display area comprises:
a first odd-numbered row in which the red sub-pixel, the green sub-pixel, the blue sub-pixel, and the white sub-pixel are alternatingly and sequentially disposed in a row direction,
a first even-numbered row in which the blue sub-pixel, the white sub-pixel, the red sub-pixel, and the green sub-pixel are alternatingly and sequentially disposed in the row direction,
a second odd-numbered row in which the blue sub-pixel, the white sub-pixel, the red sub-pixel, and the green sub-pixel are alternatingly and sequentially disposed in the row direction, and
a second even-numbered row in which the red sub-pixel, the green sub-pixel, the blue sub-pixel, and the white sub-pixel are alternatingly and sequentially disposed in the row direction.

9. The apparatus of claim 8, wherein each odd-numbered row of the image display area constitutes a right eye image region and each even-numbered row of the image display area constitutes a left eye image region.

10. The apparatus of claim 9, wherein right-handed circularly polarizing parts of the retarder are disposed corresponding to the right eye image regions, and left-handed circularly polarizing parts of the retarder are disposed corresponding to the left eye image regions.

11. The apparatus of claim 10, wherein an image corresponding to each pixel is displayed using a sub-pixel rendering method.

12. The apparatus of claim 1, wherein the first sub-pixel, the second sub-pixel, the third sub-pixel and the fourth sub-pixel operate as a single pixel to display a two-dimensional image.
